(19) United States
(12) Patent Application Publication
(10) Pub. No.: US 2026/0351262 A1
(43) Pub. Date: Nov. 5, 2026

(54) METHOD AND SYSTEM FOR DENOISING AND TRACING CROSS-CHANNEL FORGED SPEECH

(71) Applicant: ZHEJIANG UNIVERSITY, Hangzhou (CN)

(72) Inventors: Wenyuan XU, Hangzhou (CN); Yanjiao Chen, Hangzhou (CN); Yushi Cheng, Hangzhou (CN)

(73) Assignee: ZHEJIANG UNIVERSITY, Hangzhou (CN)

(21) Appl. No.: 19/643,840

(22) Filed: Apr. 10, 2026

Related U.S. Application Data
(63) Continuation of application No. PCT/CN2025/095287, filed on May 16, 2025.

(30) Foreign Application Priority Data
Apr. 2, 2025 (CN) 202510407366.9

(51) Int. Cl. G10L 17/26; G10L 17/02; G10L 17/04; G10L 17/06; G10L 17/20; G10L 21/0216

(52) U.S. Cl. CPC G10L 17/26; G10L 17/02; G10L 17/04; G10L 17/06; G10L 17/20; G10L 21/0216

(57) ABSTRACT

A method and a system for denoising and tracing cross-channel forged speech are provided. A voiceprint tracing module based on confounding feature elimination is constructed, the confounding feature of a target speaker voiceprint is eliminated through residual orthogonal calculation, and original voiceprint information of a forged speech suspect is extracted; a joint training framework oriented to channel-noise decoupling is established, and interference of cross-channel noise on voiceprint features is suppressed by using noise separation capability of an autoencoder and robustness of the voiceprint tracing module; and a voiceprint tracing inference application system for forged speech is constructed based on denoised voiceprint features, and tracing of the forged speech suspect is achieved through speaker identification or authentication algorithms. The method and the system can achieve precise extraction of original speaker voiceprint features of forged speech, and significantly improves accuracy of speech forensics and reliability in practical application.

### CROSS REFERENCE TO THE RELATED APPLICATIONS

This application is a continuation application of International Application No. PCT/CN2025/095287, filed on May 16, 2025, which is based upon and claims priority to Chinese Patent Application No. 202510407366.9, filed on Apr. 2, 2025, the entire contents of which are incorporated herein by reference.

### TECHNICAL FIELD

The present invention relates to the technical field of artificial intelligence, and more specifically, to a method and a system for denoising and tracing cross-channel forged speech.

### BACKGROUND

With the wide application of speech communication technology, the authenticity and credibility of speech signals have become increasingly prominent. In addition, the authenticity and credibility of speech signals have been more pronounced in the context of the rapid development of forged speech technologies, such as speech synthesis and voice conversion. Forged speech technologies generate speech highly similar to a target speaker voiceprint, which may be used for malicious activities such as fraud, identity impersonation, and public opinion manipulation, posing a serious threat to social security and personal privacy. With the widespread adoption of telephone communication and extensive application of telephone recording, speech analysis has become a key tool in criminal forensics. However, audio data processed by forged speech may compromise the authenticity and integrity of speech forensics. In particular, forged speech technologies distort the speech features of the original speaker, making it extremely difficult to identify the real speaker behind the forged speech. In current speech communication scenarios, transmission channels are diverse, and speech signals are usually transmitted through different communication channels, such as telephone networks, the Internet, and wireless transmission. Each channel has unique transmission characteristics, including bandwidth limitations, multipath effects, and noise interference. Existing research efforts have primarily focused on determining whether a speech sample is authentic or forged, but fail to effectively trace the source of forged speech samples. Technically, residual original speaker voiceprint information in forged speech exhibits sparse characteristics and is highly coupled with target speaker voiceprint information, resulting in difficulties in formalizing and accurately extracting the voiceprint to be traced.

Therefore, it is an issue required to be resolved urgently by those skilled in the art to provide a method and a system for denoising and tracing forged speech across channels, so as to solve the difficulties in the prior art.

### SUMMARY

In view of the foregoing, the present invention provides a method and a system for denoising and tracing cross-channel forged speech, where a voiceprint tracing model is constructed based on residual orthogonal calculation, channel-independent features are effectively extracted in combination with a denoising training framework, and robustness of forged speech tracing under a cross-channel environment is improved by constructing a generalized inference system.

To achieve the above objective, the present invention provides the following technical solution.

A method for denoising and tracing cross-channel forged speech includes the following steps:
S1. constructing a voiceprint tracing module based on confounding feature elimination, eliminating confounding features of a target speaker voiceprint through residual orthogonal calculation, and extracting original voiceprint information of a forged speech suspect;
S2. establishing a joint training framework oriented to channel noise decoupling, and suppressing interference of cross-channel noise on voiceprint features by using noise separation capability of an autoencoder and robustness of a voiceprint tracing model; and
S3. constructing a voiceprint tracing inference application system for forged speech based on denoised voiceprint features, and implementing tracing of the forged speech suspect under a cross-channel scenario through a speaker identification algorithm or a speaker authentication algorithm.

According to the method, optionally, constructing the voiceprint tracing module based on confounding feature elimination in the S1 specifically includes:
including voiceprint feature extraction and the voiceprint tracing model; first obtaining voiceprint features by using a representation model based on a time-delay neural network (TDNN);
then eliminating confounding features of a target speaker by the voiceprint tracing model through residual orthogonal (RO) calculation; and obtaining voiceprint features of a forged speech suspect through dimensional normalization.

According to the method, optionally, obtaining the voiceprint features by the representation model based on the TDNN specifically includes:

expanding a receptive field along a temporal axis by using one TDNN module and three squeeze-and-excitation residual network (SE-Res2Block) modules to extract temporal features of speech; where the TDNN module includes sequentially a one-dimensional convolution (Conv1D) layer, a rectified linear unit (ReLU) layer, and a batch normalization (BN) layer; the SE-Res2Block module includes sequentially three TDNN modules and a squeeze-and-excitation (SE) layer, a one-dimensional convolution (Conv1D) layer of the second TDNN module is replaced by a one-dimensional dilated convolution layer; outputs of the three SE-Res2Block modules are superimposed as an output of a feature extraction module E_{M}; and the feature extraction module E_{M} uses speech of a forged speaker as main input and real speech of a speaker as reference input, and feature outputs of the speeches serve as inputs to the voiceprint tracing model.

According to the method, optionally, the RO calculation performed by the voiceprint tracing model specifically includes:
decomposing an input forged speech feature vector M into a component [symbol] parallel to and a component M_{⊥} orthogonal to a target speaker speech feature vector N;
calculating an average vector of N along a temporal axis:

$$\overline{N} = \frac{1}{{T}_{N}} {\sum }_{i = 1}^{{T}_{N}} {N}_{i}$$

where Nᵢ represents an i-th frame of N, and T_{N} represents a total number of frames of N;
calculating a unit direction vector n̅ of N̅:

$$\overline{n} = \frac{\overline{N}}{\vert \overline{N} \vert + ϵ}$$

where ∈ is a minimum value to avoid computational error caused by an excessively small |N̅|;
decomposing M into [symbol] and M_{⊥}:

M_{∥}=n̅(n̅^{T}M),

M_{⊥}=M− [symbol] =M−n̅(n̅^{T}M)=(I−n̅n̅^{T})M
where I represents an identity matrix, and n̅^{T} represents a transpose of n̅; and
adding M_{⊥} processed by a TDNN to the original forged speech feature vector M through a residual connection, so as to obtain a feature output represented as M+TDNN(M_{⊥}).

According to the method, optionally, establishing the joint training framework oriented to channel noise decoupling in the S2 specifically includes:

based on training of the voiceprint tracing module, introducing a denoising decoupling module oriented to channel noise, where the denoising decoupling module includes a feature extraction module E_{M} of the voiceprint tracing module, a noise decoupling encoder E_{c}, and a feature reconstruction decoder D;

extracting a forged speech feature vector M from input speech by using the feature extraction module E_{M}, obtaining voiceprint tracing loss through voiceprint information enhancement after restoring voiceprint information of a suspect by the voiceprint tracing model, and separating channel noise features C irrelevant to a target speaker by using the noise decoupling encoder E_{c}; and recombining the forged speech feature vector M and the channel noise features C, transmitting a recombined result to the feature reconstruction decoder D to generate a reconstruction result of the input speech, and performing joint training by introducing a speech reconstruction loss, so as to eliminate and suppress interference of cross-channel noise.

According to the method, optionally, obtaining the voiceprint tracing loss through voiceprint information enhancement specifically includes:
adding a fully connected layer after the voiceprint tracing module, so as to determine validity of the traced suspect voiceprint; and constraining the traced voiceprint to be closer to the real suspect voiceprint by replacing a softmax loss of a classification layer with additive angular margin (AAM) loss.

According to the method, optionally, the speech reconstruction loss specifically includes:
decoupling channel noise features C irrelevant to the speaker from input speech x by the noise decoupling encoder E_{c}, C=E_{c}(x), transmitting results processed by the feature extraction module E_{M} and the noise decoupling encoder E_{c} to the feature reconstruction decoder D, so as to obtain a reconstructed input \hat{x}:

\hat{x}=D(E_{c}(x)⊕E_{M}(x))
minimizing a difference between the reconstructed input \hat{x} and the input speech x to obtain the speech reconstruction loss [symbol] _{rec}, so as to effectively separate speaker information and channel information independent of the speaker through training, and [symbol] _{rec} is represented by a mean square error loss:

$${\text{?}}_{r e c} = \frac{1}{𝒩} {\sum }_{i = 1}^{𝒩} {( {\hat{x}}_{i} - {x}_{i} )}^{2}$$

where [symbol] is a number of speech training samples under a training framework, xᵢ is an i-th speech sample, and \hat{x}ᵢ is a reconstructed result corresponding to the speech sample.

According to the method, optionally, the specific content of constructing the voiceprint tracing inference application system for forged speech in the step S3 is as follows:
during an inference stage, the voiceprint tracing inference application system compares reconstructed input forged speech with real speech of possible suspects to determine whether the traced voiceprint matches a suspect through a speaker verification or identification model;
in a speaker verification scenario, only one possible suspect v with a voiceprint v is considered, given a traced voiceprint feature u, a similarity score S(u, v) between an extracted voiceprint and a registered voiceprint is calculated, and if the similarity score exceeds a threshold, the real speaker of the forged speech is determined to be v; and
in a speaker identification scenario, a set of possible suspects V with voiceprints {vᵢ}_{i∈V} is considered, the speaker identification is to determine which suspect is most likely the real speaker of the forged speech by comparing the traced voiceprint with each suspect, calculate similarity scores S(u, vᵢ), and infer a real suspect v corresponding to the highest similarity score:

$$v = arg {max}_{i ∈ V} S ( u , {v}_{i} ) .$$

A system for denoising and tracing cross-channel forged speech implements the method for denoising and tracing cross-channel forged speech according to any one of the foregoing aspects, and includes sequentially a voiceprint information tracing module, a joint training framework module, and a system construction module; where
the voiceprint information tracing module is configured to construct a voiceprint tracing module based on confounding feature elimination, eliminate confounding features of a target speaker voiceprint through residual orthogonal calculation, and extract original voiceprint information of a forged speech suspect;
the joint training framework construction module is configured to establish a joint training framework oriented to channel noise decoupling, suppress interference of cross-channel noise on voiceprint features by using noise separation capability of an autoencoder and robustness of a voiceprint tracing model; and
the system construction module is configured to construct a voiceprint tracing inference application system for forged speech based on denoised voiceprint features, and implement tracing of the forged speech suspect under a cross-channel scenario through a speaker identification algorithm or a speaker authentication algorithm.

It may be known from the foregoing technical solutions that, compared with the prior art, the present invention provides a method and a system for denoising and tracing cross-channel forged speech, which has the following beneficial effects:

The present invention can achieve precise extraction of original speaker voiceprint features of forged speech, and significantly improves accuracy of speech forensics and reliability in practical application by constructing a voiceprint tracing module for confounding feature elimination and combining model training design for channel denoising.

### BRIEF DESCRIPTION OF THE DRAWINGS

To more clearly illustrate the technical solutions in the embodiments of the present invention or in the prior art, the drawings required to be used in the description of the embodiments or the prior art are briefly introduced below. It is obvious that the drawings in the description below are merely embodiments of the present invention, and those of ordinary skill in the art can obtain other drawings according to the drawings provided without creative efforts.

FIG. 1 is a flowchart of a method for denoising and tracing cross-channel forged speech according to the present invention;

FIG. 2 is a schematic diagram of a model structure of a voiceprint tracing module according to the present invention;

FIG. 3 is a schematic diagram of a structure of a joint training framework oriented to channel noise decoupling according to the present invention; and

FIG. 4 is a flowchart of a voiceprint tracing inference application system according to the present invention.

### DETAILED DESCRIPTION OF THE EMBODIMENTS

The following clearly and completely describes the technical solutions in the embodiments of the present invention with reference to drawings in the embodiments of the present invention. It is clear that the described embodiments are merely a part rather than all of the embodiments of the present invention. Based on the embodiments of the present invention, all other embodiments obtained by those of ordinary skill in the art without creative efforts shall fall within the protection scope of the present invention.

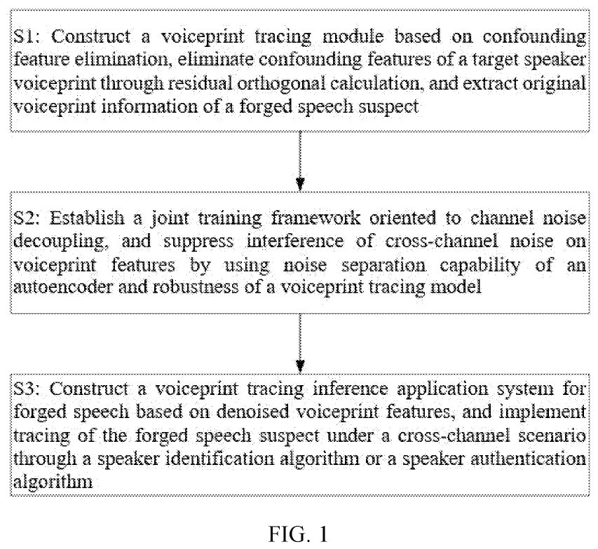

Referring to FIG. 1, the present invention discloses a method for denoising and tracing cross-channel forged speech, which includes the following steps:
S1. constructing a voiceprint tracing module based on confounding feature elimination, eliminating confounding features of a target speaker voiceprint through residual orthogonal calculation, and extracting original voiceprint information of a forged speech suspect;
S2. establishing a joint training framework oriented to channel noise decoupling, and suppressing interference of cross-channel noise on voiceprint features by using noise separation capability of an autoencoder and robustness of a voiceprint tracing model; and
S3. constructing a voiceprint tracing inference application system for forged speech based on denoised voiceprint features, and implementing tracing of the forged speech suspect under a cross-channel scenario through a speaker identification algorithm or a speaker authentication algorithm.

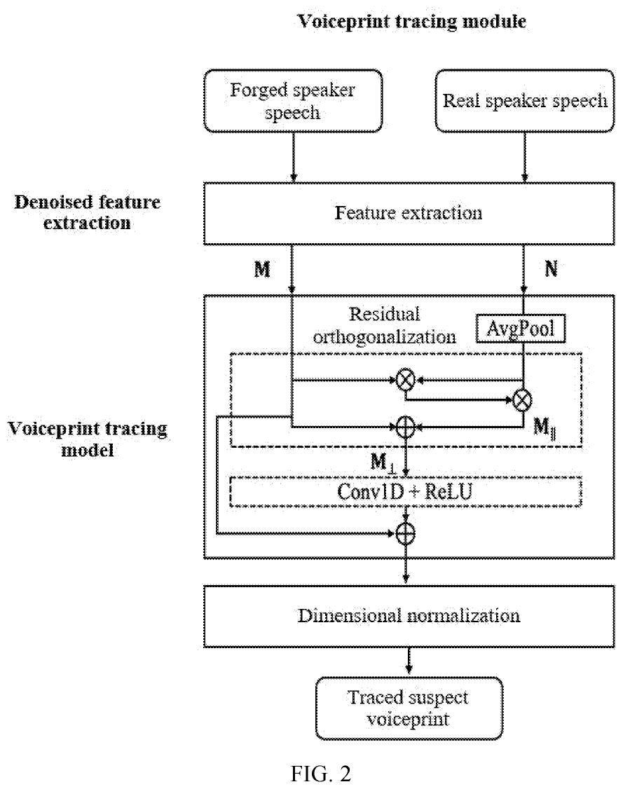

Further, referring to FIG. 2, constructing the voiceprint tracing module based on confounding feature elimination in the S1 specifically includes:
including voiceprint feature extraction and the voiceprint tracing model; first obtaining voiceprint features by using a representation model based on a time-delay neural network (TDNN);
then eliminating confounding features of a target speaker by the voiceprint tracing model through residual orthogonal (RO) calculation; and obtaining voiceprint features of a forged speech suspect through dimensional normalization.

Further, obtaining the voiceprint features by the representation model based on the TDNN specifically includes:
expanding a receptive field along a temporal axis by using one TDNN module and three squeeze-and-excitation residual network (SE-Res2Block) modules to extract temporal features of speech; where the TDNN module includes sequentially a one-dimensional convolution (Conv1D) layer, a rectified linear unit (ReLU) layer, and a batch normalization (BN) layer; the SE-Res2Block module includes sequentially three TDNN modules and a squeeze-and-excitation (SE) layer, a one-dimensional convolution (Conv1D) layer of the second TDNN module is replaced by a one-dimensional dilated convolution layer; outputs of the three SE-Res2Block modules are superimposed as an output of a feature extraction module E_{M}; and the feature extraction module E_{M} uses speech of a forged speaker as main input and real speech of a speaker as reference input, and feature outputs of the speeches serve as inputs to the voiceprint tracing model.

Specifically, in the SE-Res2Block module, three TDNN modules are configured to extract temporal-domain features, and the SE layer establishes correlations among all channels.

Further, the RO calculation performed by the voiceprint tracing model specifically includes:
decomposing an input forged speech feature vector M into a component [symbol] parallel to and a component M_{⊥} orthogonal to a target speaker speech feature vector N;
calculating an average vector of N along a temporal axis:

$$\overline{N} = \frac{1}{{T}_{N}} {\sum }_{i = 1}^{{T}_{N}} {N}_{i}$$

where Nᵢ represents an i-th frame of N, and T_{N} represents a total number of frames of N;
calculating a unit direction vector n̅ of N̅:

$$\overline{n} = \frac{\overline{N}}{\vert \overline{N} \vert + ϵ}$$

where ∈ is a minimum value to avoid computational error caused by an excessively small |N̅|;
decomposing M into [symbol] and M_{⊥}:

[symbol]

=n̅(n̅^{T}M),

M_{⊥}=M− [symbol] =M−n̅(n̅^{T}M)=(I−n̅n̅^{T})M
where I represents an identity matrix, and n̅^{T} represents a transpose of n̅; and
adding M_{⊥} processed by a TDNN to the original forged speech feature vector M through a residual connection, so as to obtain a feature output represented as M+TDNN(M_{⊥}).

Further, referring to FIG. 3, establishing the joint training framework oriented to channel noise decoupling in the S2 specifically includes:
based on training of the voiceprint tracing module, introducing a denoising decoupling module oriented to channel noise, where the denoising decoupling module includes a feature extraction module E_{M} of the voiceprint tracing module, a noise decoupling encoder E_{c}, and a feature reconstruction decoder D;
extracting a forged speech feature vector M from input speech by using the feature extraction module E_{M}, obtaining voiceprint tracing loss through voiceprint information enhancement after restoring voiceprint information of a suspect by the voiceprint tracing model, and separating channel noise features C irrelevant to a target speaker by using the noise decoupling encoder E_{c}; and recombining the forged speech feature vector M and the channel noise features C, transmitting a recombined result to the feature reconstruction decoder D to generate a reconstruction result of the input speech, and performing joint training by introducing a speech reconstruction loss, so as to eliminate and suppress interference of cross-channel noise.

Further, obtaining the voiceprint tracing loss through voiceprint information enhancement specifically includes:
adding a fully connected layer after the voiceprint tracing module, so as to determine validity of the traced suspect voiceprint; and constraining the traced voiceprint to be closer to the real suspect voiceprint by replacing a softmax loss of a classification layer with additive angular margin (AAM) loss.

Further, the speech reconstruction loss specifically includes:
decoupling channel noise features C irrelevant to the speaker from input speech x by the noise decoupling encoder E_{c}, C=E_{c}(x), transmitting results processed by the feature extraction module E_{M} and the noise decoupling encoder E_{c} to the feature reconstruction decoder D, so as to obtain a reconstructed input \hat{x}:

\hat{x}=D(E_{c}(x)⊕E_{M}(x))
minimizing a difference between the reconstructed input \hat{x} and the input speech x to obtain the speech reconstruction loss [symbol] _{rec}, so as to effectively separate speaker information and channel information independent of the speaker through training, and [symbol] _{rec} is represented by a mean square error loss:

$${\text{?}}_{rec} = \frac{1}{𝒩} {\sum }_{i = 1}^{𝒩} {( {\hat{x}}_{i} - {x}_{i} )}^{2}$$

where [symbol] is a number of speech training samples under a training framework, xᵢ is an i-th speech sample, and \hat{x}ᵢ is a reconstructed result corresponding to the speech sample.

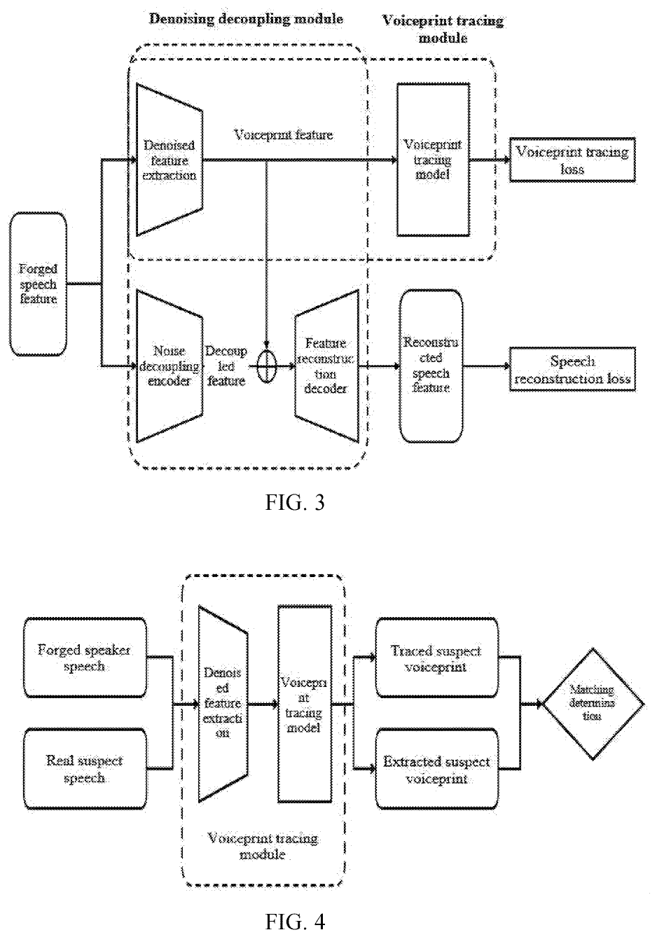

Further, referring to FIG. 4, the specific content of constructing the voiceprint tracing inference application system for forged speech in the step S3 is as follows:
during an inference stage, the voiceprint tracing inference application system compares reconstructed input forged speech with real speech of possible suspects to determine whether the traced voiceprint matches a suspect through a speaker verification or identification model;
in a speaker verification scenario, only one possible suspect v with a voiceprint v is considered, given a traced voiceprint feature u, a similarity score S(u, v) between an extracted voiceprint and a registered voiceprint is calculated, and if the similarity score exceeds a threshold φ, the real speaker of the forged speech is determined to be v; and
in a speaker identification scenario, a set of possible suspects V with voiceprints {vᵢ}_{i∈V} is considered, the speaker identification is to determine which suspect is most likely the real speaker of the forged speech by comparing the traced voiceprint with each suspect, calculate similarity scores S(u, vᵢ), and infer a real suspect v corresponding to the highest similarity score:

$$v = arg {max}_{i ∈ V} S ( u , {v}_{i} ) .$$

Corresponding to the method described with reference to FIG. 1, the present invention further provides a system for denoising and tracing cross-channel forged speech, configured to implement the method shown in FIG. 1, which includes sequentially a voiceprint information tracing module, a joint training framework construction module, and a system construction module; where,
the voiceprint information tracing module is configured to construct a voiceprint tracing module based on confounding feature elimination, eliminate confounding features of a target speaker voiceprint through residual orthogonal calculation, and extract original voiceprint information of a forged speech suspect;
the joint training framework construction module is configured to establish a joint training framework oriented to channel noise decoupling, suppress interference of cross-channel noise on voiceprint features by using noise separation capability of an autoencoder and robustness of a voiceprint tracing model; and
the system construction module is configured to construct a voiceprint tracing inference application system for forged speech based on denoised voiceprint features, and implement tracing of the forged speech suspect under a cross-channel scenario through a speaker identification algorithm or a speaker authentication algorithm.

In a specific embodiment,
Step 1. A voiceprint tracing module based on confounding feature elimination is designed and constructed, and includes voiceprint feature extraction and voiceprint tracing model. A feature extraction model E_{M}E_M adopts a stacked architecture including one time-delay neural network (TDNN) module and three squeeze-and-excitation residual network (SE-Res2Blocks) modules. The forged speech x and reference speech x_{evd} are input, and a forged speech feature vector M and a target speaker speech feature vector N are obtained by the TDNN module (including a one-dimensional convolution layer, a ReLU layer, and a BN layer) and the three SE-Res2Block modules. Each SE-Res2Block module includes three TDNN modules and one squeeze-and-excitation layer, and a one-dimensional convolution layer of a second TDNN module is replaced with a one-dimensional dilated convolution layer. Subsequently, the voiceprint tracing model eliminates confounding features of a target speaker through residual orthogonal (RO) calculation, where the forged speech feature vector M is decomposed into a component [symbol] parallel to and a component M_{⊥} orthogonal to the target speaker speech feature vector N. The RO calculation aims to eliminate the parallel component [symbol] , thereby suppressing influence of target speaker voiceprint features in the forged speech feature vector.

RO(M)=TDNN(M_{⊥})+M
Finally, voiceprint features of the forged speech suspect are extracted through dimensional normalization.
Step 2. Based on the foregoing constructed voiceprint tracing module, a training framework introduces a denoising decoupling module oriented to channel noise. The denoising decoupling module includes the feature extraction model E_{M} of the voiceprint tracing module, a noise decoupling encoder E_{c}C, and a feature reconstruction decoder D. The noise decoupling encoder E_{c} separates channel noise features C=E_{c}(x) irrelevant to a target speaker from input forged speech x. The feature reconstruction decoder D recombines a forged speech feature vector for voiceprint tracing M=E_{M}(x) with voiceprint-irrelevant features to obtain a reconstructed speech feature output \hat{x}=D(M⊕C). Oriented to a cross-channel scenario, the training framework performs joint training using the voiceprint tracing loss and the speech reconstruction loss. A fully connected layer is added after the voiceprint tracing module for output, and an additive angular margin (AAM) softmax is adopted for loss calculation, thereby explicitly constraining a traced voiceprint to be closer to a real suspect voiceprint.

$${\text{?}}_{AAM} = - \frac{1}{𝒩} {\sum }_{i = 1}^{𝒩} {\sum }_{j} {y}_{i , j} log {p}_{i , j}$$

where [symbol] is a number of speech training samples in the training framework, p_{i,j} represents the AAM softmax output of an i-th sample for a j-th class, and y_{i,j} represents a corresponding ground-truth label.
Simultaneously, a speech reconstruction loss [symbol] _{rec} is calculated, and by minimizing a difference between \hat{x} and x, the training can effectively separate a forged speech feature vector M of the speaker from channel noise features C that are independent of the speaker. [symbol] _{rec} is represented by a mean square error loss:

$${\text{?}}_{rec} = \frac{1}{𝒩} {\sum }_{i = 1}^{𝒩} {( {\hat{x}}_{i} - {x}_{i} )}^{2}$$

The total loss driving the training is represented as: [symbol] = [symbol] _{rec}+ [symbol] _{AAM}.
The training updates model parameters using an Adam optimizer with an initial learning rate of 1e-3, a weight decay of 2e-6, and a batch size of 24 samples. The training is conducted for 4-8 epochs and terminates when the training loss [symbol] <0.1.
Step 3. After the voiceprint tracing model is trained with denoising and the parameters are fixed, a cross-channel forged speech tracing inference system is constructed. During an inference stage, the system receives input forged speech and real speech of possible suspects, and determines whether the traced voiceprint matches a suspect through a speaker verification or speaker identification model.
In a speaker verification scenario, only one possible suspect v with a voiceprint v is considered, given a traced voiceprint feature u, and a similarity score S(u, v) between an extracted voiceprint and a registered voiceprint is calculated. If the similarity score exceeds a threshold q, the real speaker of the forged speech is determined to be v.
In a speaker recognition scenario, a set of possible suspects V with voiceprints {vᵢ}_{i∈V} is considered. The speaker identification is to determine which suspect is most likely the real speaker of the forged speech by comparing the traced voiceprint with each suspect, calculate similarity scores S(u, vᵢ), and infer a real suspect v corresponding to the highest similarity score:

$$v = arg {max}_{i ∈ V} S ( u , {v}_{i} ) .$$

The voiceprint set supports dynamic updating, and enhances generalization of the tracing capability without requiring retraining of the model. A similarity calculation module can be deployed in parallel to accelerate comparisons across a large number of suspects.

Embodiments in this specification are all described in a progressive manner, for same or similar parts in embodiments, reference may be made to these embodiments, and each embodiment focuses on a difference from other embodiments. Since the system disclosed in the embodiment corresponds to the method disclosed in the embodiment, the description is relatively simple, and reference may be made to the partial description of the method.

The above description of the disclosed embodiments enables those skilled in the art to implement or use the present invention. Various modifications to these embodiments will be readily apparent to those skilled in the art, and the generic principles defined herein may be applied to other embodiments without departing from the spirit or scope of the present invention. Thus, the present invention is not intended to be limited to these embodiments shown herein but is to be accorded the broadest scope consistent with the principles and novel features disclosed herein.

What is claimed is:

1. A method for denoising and tracing cross-channel forged speech, comprising the following steps:
S1. constructing a voiceprint tracing module based on confounding feature elimination, eliminating confounding features of a target speaker voiceprint through residual orthogonal calculation, and extracting original voiceprint information of a forged speech suspect;
S2. establishing a joint training framework oriented to channel noise decoupling, and suppressing interference of cross-channel noise on voiceprint features by using noise separation capability of an autoencoder and robustness of a voiceprint tracing model; and
S3. constructing a voiceprint tracing inference application system for forged speech based on denoised voiceprint features, and implementing tracing of the forged speech suspect under a cross-channel scenario through a speaker identification algorithm or a speaker authentication algorithm;
wherein establishing the joint training framework oriented to channel noise decoupling in the S2 specifically comprises:
based on training of the voiceprint tracing module, introducing a denoising decoupling module oriented to channel noise, wherein the denoising decoupling module comprises a feature extraction module E_{M} of the voiceprint tracing module, a noise decoupling encoder E_{c}, and a feature reconstruction decoder D;
extracting a forged speech feature vector M from input speech by using the feature extraction module E_{M}, obtaining voiceprint tracing loss through voiceprint information enhancement after restoring voiceprint information of a suspect by the voiceprint tracing model, and separating channel noise features C irrelevant to a target speaker by using the noise decoupling encoder E_{c};
and recombining the forged speech feature vector M and the channel noise features C, transmitting a recombined result to the feature reconstruction decoder D to generate a reconstruction result of the input speech, and performing joint training by introducing a speech reconstruction loss, so as to eliminate and suppress interference of cross-channel noise.

2. The method for denoising and tracing cross-channel forged speech according to claim 1,
wherein constructing the voiceprint tracing module based on confounding feature elimination in the S1 specifically comprises:
comprising voiceprint feature extraction and the voiceprint tracing model; first obtaining voiceprint features by using a representation model based on a time-delay neural network (TDNN);
then eliminating confounding features of the target speaker by the voiceprint tracing model through residual orthogonal (RO) calculation; and obtaining voiceprint features of the forged speech suspect through dimensional normalization.

3. The method for denoising and tracing cross-channel forged speech according to claim 2, wherein obtaining the voiceprint features by the representation model based on the TDNN specifically comprises:
expanding a receptive field along a temporal axis by using one TDNN module and three squeeze-and-excitation residual network (SE-Res2Block) modules to extract temporal features of speech; wherein the TDNN module comprises sequentially a one-dimensional convolution (Conv1D) layer, a rectified linear unit (ReLU) layer, and a batch normalization (BN) layer; the SE-Res2Block module comprises sequentially three TDNN modules and a squeeze-and-excitation (SE) layer, a one-dimensional convolution (Conv1D) layer of the second TDNN module is replaced by a one-dimensional dilated convolution layer; outputs of the three SE-Res2Block modules are superimposed as an output of the feature extraction module E_{M}; and the feature extraction module E_{M} uses speech of a forged speaker as main input and real speech of a speaker as reference input, and feature outputs of the speeches serve as inputs to the voiceprint tracing model.

4. The method for denoising and tracing cross-channel forged speech according to claim 2, wherein the RO calculation performed by the voiceprint tracing model specifically comprises:
decomposing an input forged speech feature vector M into a component [symbol] parallel to and a component M_{⊥} orthogonal to a target speaker speech feature vector N;
calculating an average vector of N along a temporal axis:
$$\overline{N} = \frac{1}{{T}_{N}} {\sum }_{i = 1}^{{T}_{N}} {N}_{i}$$
wherein Nᵢ represents an i-th frame of N, and T_{N} represents a total number of frames of N;
calculating a unit direction vector n̅ of N̅:
$$\overline{n} = \frac{\overline{N}}{\vert \overline{N} \vert + ϵ}$$
wherein ∈ is a minimum value to avoid computational error caused by an excessively small |N̅|;
decomposing M into [symbol] and M_{⊥}: [symbol]
=n̅(n̅^{T}M),
M_{⊥}=M− [symbol] =M−n̅(n̅^{T}M)=(I−n̅n̅^{T})M
wherein I represents an identity matrix, and n̅^{T} represents a transpose of n̅; and
adding M_{⊥} processed by a TDNN to the original forged speech feature vector M through a residual connection, so as to obtain a feature output represented as M+TDNN(M_{⊥}).

5. The method for denoising and tracing cross-channel forged speech according to claim 1, wherein obtaining the voiceprint tracing loss through voiceprint information enhancement specifically comprises:
adding a fully connected layer after the voiceprint tracing module, so as to determine validity of a traced suspect voiceprint; and constraining the traced voiceprint to be closer to a real suspect voiceprint by replacing a softmax loss of a classification layer with additive angular margin (AAM) loss.

6. The method for denoising and tracing cross-channel forged speech according to claim 1, wherein the speech reconstruction loss specifically comprises:
decoupling the channel noise features C irrelevant to the speaker from input speech x by the noise decoupling encoder E_{c}, C=E_{c}(x), transmitting results processed by the feature extraction module E_{M} and the noise decoupling encoder E_{c} to the feature reconstruction decoder D, so as to obtain a reconstructed input \hat{x}:
\hat{x}=D(E_{c}(x)⊕E_{M}(x))
minimizing a difference between the reconstructed input \hat{x} and the input speech x to obtain the speech reconstruction loss [symbol] _{rec}, so as to effectively separate speaker information and channel information independent of the speaker through training, and [symbol] _{rec} is represented by a mean square error loss:
$${\text{?}}_{rec} = \frac{1}{𝒩} {\sum }_{i = 1}^{𝒩} {( {\hat{x}}_{i} - {x}_{i} )}^{2}$$
wherein [symbol] is a number of speech training samples under a training framework, xᵢ is an i-th speech sample, and \hat{x}ᵢ is a reconstructed result corresponding to the speech sample.

7. The method for denoising and tracing cross-channel forged speech according to claim 1, wherein a specific content of constructing the voiceprint tracing inference application system for forged speech in the step S3 is as follows:
during an inference stage, the voiceprint tracing inference application system compares reconstructed input forged speech with real speech of possible suspects to determine whether a traced voiceprint matches the suspect through a speaker verification or identification model;
in a speaker verification scenario, only one possible suspect v with a voiceprint v is considered, given a traced voiceprint feature u, a similarity score S(u, v) between an extracted voiceprint and a registered voiceprint is calculated, and if the similarity score exceeds a threshold φ, a real speaker of the forged speech is determined to be v; and
in a speaker identification scenario, a set of possible suspects V with voiceprints {vᵢ}_{i∈V} is considered, a speaker identification is to determine which suspect is most likely the real speaker of the forged speech by comparing the traced voiceprint with each suspect, calculate similarity scores S(u, vᵢ), and infer a real suspect v corresponding to a highest similarity score:
$$v = arg {max}_{i ∈ V} S ( u , {v}_{i} ) .$$

8. A system for denoising and tracing cross-channel forged speech, implementing the method for denoising and tracing cross-channel forged speech according to claim 1, and comprising sequentially a voiceprint information tracing module, a joint training framework module, and a system construction module; wherein
the voiceprint information tracing module is configured to construct the voiceprint tracing module based on confounding feature elimination, eliminate the confounding features of the target speaker voiceprint through residual orthogonal calculation, and extract the original voiceprint information of the forged speech suspect;
the joint training framework construction module is configured to establish the joint training framework oriented to channel noise decoupling, suppress interference of cross-channel noise on the voiceprint features by using noise separation capability of the autoencoder and robustness of the voiceprint tracing model; and
the system construction module is configured to construct the voiceprint tracing inference application system for forged speech based on the denoised voiceprint features, and implement tracing of the forged speech suspect under the cross-channel scenario through the speaker identification algorithm or the speaker authentication algorithm.

9. The system according to claim 8, wherein in the method, constructing the voiceprint tracing module based on confounding feature elimination in the S1 specifically comprises:
comprising voiceprint feature extraction and the voiceprint tracing model; first obtaining voiceprint features by using a representation model based on a time-delay neural network (TDNN); then eliminating confounding features of the target speaker by the voiceprint tracing model through residual orthogonal (RO) calculation; and obtaining voiceprint features of the forged speech suspect through dimensional normalization.

10. The system according to claim 9, wherein in the method, obtaining the voiceprint features by the representation model based on the TDNN specifically comprises:
expanding a receptive field along a temporal axis by using one TDNN module and three squeeze-and-excitation residual network (SE-Res2Block) modules to extract temporal features of speech; wherein the TDNN module comprises sequentially a one-dimensional convolution (Conv1D) layer, a rectified linear unit (ReLU) layer, and a batch normalization (BN) layer; the SE-Res2Block module comprises sequentially three TDNN modules and a squeeze-and-excitation (SE) layer, a one-dimensional convolution (Conv1D) layer of the second TDNN module is replaced by a one-dimensional dilated convolution layer; outputs of the three SE-Res2Block modules are superimposed as an output of the feature extraction module E_{M}; and the feature extraction module E_{M} uses speech of a forged speaker as main input and real speech of a speaker as reference input, and feature outputs of the speeches serve as inputs to the voiceprint tracing model.

11. The system according to claim 9, wherein in the method, the RO calculation performed by the voiceprint tracing model specifically comprises:
decomposing an input forged speech feature vector M into a component [symbol] parallel to and a component M_{⊥} orthogonal to a target speaker speech feature vector N;
calculating an average vector of N along a temporal axis:
$$\overline{N} = \frac{1}{{T}_{N}} {\sum }_{i = 1}^{{T}_{N}} {N}_{i}$$
wherein Nᵢ represents an i-th frame of N, and T_{N} represents a total number of frames of N;
calculating a unit direction vector n̅ of N̅:
$$\overline{n} = \frac{\overline{N}}{\vert \overline{N} \vert + ϵ}$$
wherein ∈ is a minimum value to avoid computational error caused by an excessively small |N̅|;
decomposing M into [symbol] and M_{⊥}: [symbol]
=n̅(n̅^{T}M),
M_{⊥}=M− [symbol] =M−n̅(n̅^{T}M)=(I−n̅n̅^{T})M
wherein I represents an identity matrix, and n̅^{T} represents a transpose of n̅; and
adding M_{⊥} processed by a TDNN to the original forged speech feature vector M through a residual connection, so as to obtain a feature output represented as M+TDNN(M_{⊥}).

12. The system according to claim 8, wherein in the method, obtaining the voiceprint tracing loss through voiceprint information enhancement specifically comprises:
adding a fully connected layer after the voiceprint tracing module, so as to determine validity of a traced suspect voiceprint; and constraining the traced voiceprint to be closer to a real suspect voiceprint by replacing a softmax loss of a classification layer with additive angular margin (AAM) loss.

13. The system according to claim 8, wherein in the method, the speech reconstruction loss specifically comprises:
decoupling the channel noise features C irrelevant to the speaker from input speech x by the noise decoupling encoder E_{c}, C=E_{c}(x), transmitting results processed by the feature extraction module E_{M} and the noise decoupling encoder E, to the feature reconstruction decoder D, so as to obtain a reconstructed input \hat{x}:
\hat{x}=D(E_{c}(x)⊕E_{M}(x))
minimizing a difference between the reconstructed input R and the input speech x to obtain the speech reconstruction loss [symbol] _{rec}, so as to effectively separate speaker information and channel information independent of the speaker through training, and [symbol] _{rec} is represented by a mean square error loss:
$${\text{?}}_{rec} = \frac{1}{𝒩} {\sum }_{i = 1}^{𝒩} {( {\hat{x}}_{i} - {x}_{i} )}^{2}$$
wherein [symbol] is a number of speech training samples under a training framework, xᵢ is an i-th speech sample, and \hat{x}ᵢ is a reconstructed result corresponding to the speech sample.

14. The system according to claim 8, wherein in the method, a specific content of constructing the voiceprint tracing inference application system for forged speech in the step S3 is as follows:
during an inference stage, the voiceprint tracing inference application system compares reconstructed input forged speech with real speech of possible suspects to determine whether a traced voiceprint matches the suspect through a speaker verification or identification model;
in a speaker verification scenario, only one possible suspect v with a voiceprint v is considered, given a traced voiceprint feature u, a similarity score S(u, v) between an extracted voiceprint and a registered voiceprint is calculated, and if the similarity score exceeds a threshold φ, a real speaker of the forged speech is determined to be v; and
in a speaker identification scenario, a set of possible suspects V with voiceprints {vᵢ}_{i∈V} is considered, a speaker identification is to determine which suspect is most likely the real speaker of the forged speech by comparing the traced voiceprint with each suspect, calculate similarity scores S(u, vᵢ), and infer a real suspect v corresponding to a highest similarity score:
$$v = arg {max}_{i ∈ V} S ( u , {v}_{i} ) .$$
